(19) United States
(12) Patent Application Publication
(10) Pub. No.: US 2022/0091818 A1
(43) Pub. Date: Mar. 24, 2022

(54) DATA FEATURE PROCESSING METHOD AND DATA FEATURE PROCESSING APPARATUS

(71) Applicant: Shanghai IceKredit, Inc., Shanghai (CN)

(72) Inventors: Lingyun GU, Shanghai (CN); Minqi XIE, Shanghai (CN); Wan DUAN, Shanghai (CN); Hui LIU, Shanghai (CN); Shuai TAO, Shanghai (CN); Jun PAN, Shanghai (CN); Tao ZHANG, Shanghai (CN)

(73) Assignee: Shanghai IceKredit, Inc., Shanghai (CN)

(21) Appl. No.: 17/380,037

(22) Filed: Jul. 20, 2021

(30) Foreign Application Priority Data
Sep. 22, 2020 (CN) 202010998380.8

(51) Int. Cl. G06F 7/24; G06F 7/32; G06K 9/62; G06N 20/00

(52) U.S. Cl. CPC G06F 7/24; G06F 7/32; G06N 20/00; G06K 9/6262; G06K 9/6288; G06K 9/6228

(57) ABSTRACT

A data feature processing method and a data feature processing apparatus are provided, which perform the following operations: sorting a plurality of groups of business data to obtain a business data sorting sequence, and determining a cross-time validation set and modeling sample data to establish a recognition model by using a preset classifier; calculating feature importance values of data features in the business data based on the recognition model and a gain indicator of the recognition model, and calculating a correlation matrix by taking the modeling sample data as a benchmark; determining to-be-selected model features based on the correlation matrix; and importing the to-be-selected model features into the preset classifier in batches to determine model benchmark performance data. In this way, a highly-correlated feature can be deleted based on an order of the feature importance values. This can reduce operation time and memory demands in a model establishment process.

### CROSS REFERENCE TO THE RELATED APPLICATIONS

This application is based upon and claims priority to Chinese Patent Application No. 202010998380.8, filed on Sep. 22, 2020, the entire contents of which are incorporated herein by reference.

### TECHNICAL FIELD

The present invention relates to the technical field of data processing, and more particularly, to a data feature processing method and a data feature processing apparatus.

### BACKGROUND

In order to improve the accuracy of analysis and recognition, it is required to use a recognition model to analyze and recognize business data. When the recognition model is trained, feature data screening plays a key role in ensuring the recognition accuracy and running performance of the recognition model. In practical application, however, the prior feature data screening method causes the recognition model to have poor prediction accuracy, to consume a lot of running time of a computer device during running, and to occupy the storage space of the computer device.

### SUMMARY

To resolve the above problems, the present invention provides a data feature processing method and a data feature processing apparatus.

According to a first aspect, a data feature processing method is provided. The method is applied to a data processing server, and includes:

obtaining a plurality of groups of business data, where each group of business data includes n data features, and n is a positive integer;

sorting the plurality of groups of business data in a reverse chronological order of business data obtaining time to obtain a business data sorting sequence; determining highly-ranked business data of a first predetermined proportion as a cross-time validation set, and lowly-ranked business data of a second predetermined proportion as modeling sample data; and taking a data feature corresponding to the modeling sample data as a model feature, and establishing a recognition model by using a preset classifier, where a sum of the first predetermined proportion and the second predetermined proportion is 1;

calculating feature importance values of the n data features based on the recognition model and a gain indicator of the recognition model, and calculating a correlation matrix of each data feature in the n data features by taking the modeling sample data as a benchmark, where the correlation matrix is an n*n matrix;

determining a plurality of target sets in the correlation matrix, where there is no duplicate element between different target sets;

deleting a data feature with a maximum feature importance value in each target set, merging remaining data features in each target set to obtain a feature set, and deleting a data feature in the n data features being identical to a data feature in the feature set to obtain to-be-selected model features, where the feature set includes m data features, the number of the to-be-selected model features is n−m, and m is a positive integer less than n;

importing the to-be-selected model features into the preset classifier in batches in a descending order of the feature importance values, and obtaining a difference between two pieces of adjacent first performance indicator data that is calculated by the preset classifier; determining whether the difference meets a preset condition; when the difference meets the preset condition, determining an automation model feature in the to-be-selected model features, and calculating second performance indicator data of the recognition model in the cross-time validation set; and determining model benchmark performance data based on the difference and the second performance indicator data; and

associatively storing the automation model feature and the model benchmark performance data.

Optionally, the step of determining the plurality of target sets in the correlation matrix includes:

selecting, from the correlation matrix, a row name and a column name of a correlation coefficient in a predetermined value range, and establishing a plurality of first sets; and

merging first sets including an identical element to obtain the plurality of target sets.

Optionally, the step of importing the to-be-selected model features into the preset classifier in batches in the descending order of the feature importance values, and obtaining the difference between two pieces of adjacent first performance indicator data that is calculated by the preset classifier includes:

sorting the to-be-selected model features in the descending order of the feature importance values to obtain a sequence of the to-be-selected model features;

importing first x to-be-selected model features in the sequence into the preset classifier, and calculating first performance indicator data corresponding to x to-be-selected model features in a test set of the preset classifier in a predetermined validation mode; and importing first 2x to-be-selected model features in the sequence into the preset classifier, and calculating first performance indicator data corresponding to 2x to-be-selected model features in the test set of the preset classifier in the predetermined validation mode, where x is a positive integer; and

calculating a difference between the first performance indicator data corresponding to the 2x to-be-selected model features and the first performance indicator data corresponding to the x to-be-selected model features.

Optionally, the step of determining whether the difference meets the preset condition includes:

determining whether the difference is greater than a predetermined threshold;

if the difference is greater than the predetermined threshold, determining that the difference does not meet the preset condition; and

if the difference is less than or equal to the predetermined threshold, determining that the difference meets the preset condition.

Optionally, the step of determining the model benchmark performance data based on the difference and the second performance indicator data includes:

calculating third performance indicator data corresponding to x to-be-selected model features in a training set of the preset classifier in the predetermined validation mode; and

determining the third performance indicator data corresponding to the x to-be-selected model features in the training set of the preset classifier in the predetermined validation mode, the first performance indicator data corresponding to the x to-be-selected model features in the test set of the preset classifier in the predetermined validation mode, and the second performance indicator data to be the model benchmark performance data.

Optionally, the method further includes:

when the difference does not meet the preset condition, importing first 3x to-be-selected model features in the sequence into the preset classifier, and calculating first performance indicator data corresponding to 3x to-be-selected model features in the test set of the preset classifier in the predetermined validation mode; and

calculating a difference between the first performance indicator data corresponding to the 3x to-be-selected model features and the first performance indicator data corresponding to the 2x to-be-selected model features, and performing the step of determining whether the difference meets the preset condition.

According to a second aspect, a data feature processing apparatus is provided. The apparatus is applied to a data processing server, and includes:

a data acquisition module, configured to obtain a plurality of groups of business data, where each group of business data includes n data features, and n is a positive integer;

a model establishment module, configured to: sort the plurality of groups of business data in a reverse chronological order of business data obtaining time to obtain a business data sorting sequence; determine highly-ranked business data of a first predetermined proportion as a cross-time validation set, and lowly-ranked business data of a second predetermined proportion as modeling sample data; and take a data feature corresponding to the modeling sample data as a model feature, and establish a recognition model by using a preset classifier, where a sum of the first predetermined proportion and the second predetermined proportion is 1;

a matrix calculation module, configured to: calculate feature importance values of the n data features based on the recognition model and a gain indicator of the recognition model, and calculate a correlation matrix of each data feature in the n data features by taking the modeling sample data as a benchmark, where the correlation matrix is an n*n matrix;

a set determining module, configured to determine a plurality of target sets in the correlation matrix, where there is no duplicate element between different target sets;

a feature deletion module, configured to: delete a data feature with a maximum feature importance value in each target set, merge remaining data features in each target set to obtain a feature set, and delete a data feature in the n data features being identical to a data feature in the feature set to obtain to-be-selected model features, where the feature set includes m data features, the number of the to-be-selected model features is n−m, and m is a positive integer less than n;

a data calculation module, configured to: import the to-be-selected model features into the preset classifier in batches in a descending order of the feature importance values, and obtain a difference between two pieces of adjacent first performance indicator data that is calculated by the preset classifier; determine whether the difference meets a preset condition; when the difference meets the preset condition, determine an automation model feature in the to-be-selected model features, and calculate second performance indicator data of the recognition model in the cross-time validation set; and determine model benchmark performance data based on the difference and the second performance indicator data; and

an associative-storage module, configured to associatively store the automation model feature and the model benchmark performance data.

Optionally,

the set determining module is specifically configured to: select, from the correlation matrix, a row name and a column name of a correlation coefficient in a predetermined value range, and establish a plurality of first sets; and merge first sets including an identical element to obtain the plurality of target sets; and

the data calculation module is specifically configured to: sort the to-be-selected model features in the descending order of the feature importance values to obtain a sequence of the to-be-selected model features; import first x to-be-selected model features in the sequence into the preset classifier, and calculate first performance indicator data corresponding to x to-be-selected model features in a test set of the preset classifier in a predetermined validation mode; import first 2x to-be-selected model features in the sequence into the preset classifier, and calculate first performance indicator data corresponding to 2x to-be-selected model features in the test set of the preset classifier in the predetermined validation mode, where x is a positive integer; and calculate a difference between the first performance indicator data corresponding to the 2x to-be-selected model features and the first performance indicator data corresponding to the x to-be-selected model features.

Optionally,

the data calculation module is further configured to:

determine whether the difference is greater than a predetermined threshold;

if the difference is greater than the predetermined threshold, determine that the difference does not meet the preset condition; and

if the difference is less than or equal to the predetermined threshold, determine that the difference meets the preset condition; and

the data calculation module is further configured to:

calculate third performance indicator data corresponding to x to-be-selected model features in a training set of the preset classifier in the predetermined validation mode; and

determine the third performance indicator data corresponding to the x to-be-selected model features in the training set of the preset classifier in the predetermined validation mode, the first performance indicator data corresponding to the x to-be-selected model features in the test set of the preset classifier in the predetermined validation mode, and the second performance indicator data to be the model benchmark performance data.

Optionally, the data calculation module is further configured to:

when the difference does not meet the preset condition, import first 3x to-be-selected model features in the sequence into the preset classifier, and calculate first performance indicator data corresponding to 3x to-be-selected model features in the test set of the preset classifier in the predetermined validation mode; and

calculate a difference between the first performance indicator data corresponding to the 3x to-be-selected model features and the first performance indicator data corresponding to the 2x to-be-selected model features, and perform the step of determining whether the difference meets the preset condition.

Beneficial Effects

The data feature processing method and the data feature processing apparatus provided in the embodiments of the present invention perform the following operations:

sorting a plurality of groups of obtained business data in a sequential order of business data obtaining time to obtain a business data sorting sequence, determining a cross-time validation set and modeling sample data, taking a data feature corresponding to the modeling sample data as a model feature, and establishing a recognition model by using a preset classifier;

calculating feature importance values of data features in the business data based on the recognition model and a gain indicator of the recognition model, and calculating a correlation matrix by taking the modeling sample data as a benchmark;

determining to-be-selected model features based on the correlation matrix; and

importing the to-be-selected model features into the preset classifier in batches; obtaining a difference between two pieces of adjacent first performance indicator data that is calculated by the preset classifier; when the difference meets a preset condition, determining an automation model feature in the to-be-selected model features, and calculating second performance indicator data of the recognition model in the cross-time validation set; and determining model benchmark performance data based on the difference and the second performance indicator data.

In this way, a highly-correlated feature can be deleted based on an order of the feature importance values. This can reduce operation time and memory demands in a model establishment process, reduce model complexity to facilitate practical application and maintenance of the model, and realize more reasonable feature selection. This can also greatly reduce, based on feature importance and model performance, resources consumed for model operation while ensuring the model performance.

### BRIEF DESCRIPTION OF THE DRAWINGS

To describe the technical solutions in the embodiments of the present invention more clearly, the following briefly describes the accompanying drawings required for describing the embodiments. It should be understood that the following accompanying drawings show merely some embodiments of the present invention, and therefore should not be regarded as a limitation on the scope. A person of ordinary skill in the art may still derive other related drawings from these accompanying drawings without creative efforts.

FIG. 1 is a flowchart of a data feature processing method according to an embodiment of the present invention;

FIG. 2 is a block diagram of functional modules of a data feature processing apparatus according to an embodiment of the present invention; and

FIG. 3 is a schematic diagram of a hardware structure of a data processing server according to an embodiment of the present invention.

### DETAILED DESCRIPTION OF THE EMBODIMENTS

For the sake of a better understanding of the above technical solutions, the technical solutions in the present invention are described in detail with reference to the accompanying drawings and specific embodiments. It should be understood that the embodiments of the present invention and specific features in the embodiments are detailed descriptions of the technical solutions in the present invention, and are not intended to limit the technical solutions in the present invention. The embodiments in the present invention and technical features in the embodiments may be combined with each other in a non-conflicting situation.

After analyzing an existing feature data screening method, the inventor finds that the existing feature data screening method mainly includes the following steps:

(1) Obtain user data (N-dimensional features) by using application software of a terminal or a web page, input the user data into a model environment, and set a minimum threshold of an area under curve (AUC) gain of a feature pair.

(2) Based on an XGBoost algorithm, obtain a 5-fold training set and a 5-fold test set through division by using a cross-validation technology, and separately calculate N average AUC values of N models determined by using N features as input model features, in the 5-fold cross-validation test set. A feature with a maximum average AUC value is selected as a 1^{st} determined model feature.

(3) Recalculate an average AUC value of each of remaining N−1 features in step (2) and one feature determined in step (2) (namely, two model features), in the 5-fold cross-validation test set separately. N−1 AUC differences are obtained by separately subtracting the maximum average AUC value in step (2) from the N−1 average AUC values. Two model features with a maximum AUC difference in the model are used as model features determined in the 2^{nd} round of calculation (one of the two features is determined in step (2)). The calculation is cyclically performed, and ends when the maximum AUC difference is less than an initially input threshold, namely, 0.005, in an m^{th} round of calculation. In this case, m−1 features determined in previous m−1 rounds of calculation are finally determined features, and are stored as a feature list.

(4) Output the feature list stored in step (3).

However, the above steps have the following technical problems:

A. The above steps consume a huge quantity of calculation resources. Specifically, in the above steps, before a feature is determined, a difference between an average AUC value of a model (the model has m+1 features) established after all n−m features not determined are separately added to determined m features, in the 5-fold validation set and a maximum average AUC value in a previous round of calculation needs to be recalculated, and then a feature corresponding to a maximum difference is selected as a model feature. This process needs to be repeated for many rounds. As a result, a huge quantity of calculation and storage resources need to be consumed when there are a large quantity of samples or features, seriously affecting convenience of use.

B. The above steps completely rely on an AUC value in the test set to determine a variable. As a result, a huge quantity of resources are consumed because a model needs to be established for each remaining variable to determine a feature, and the selected feature is only based on the AUC value and not based on characteristics of the algorithm.

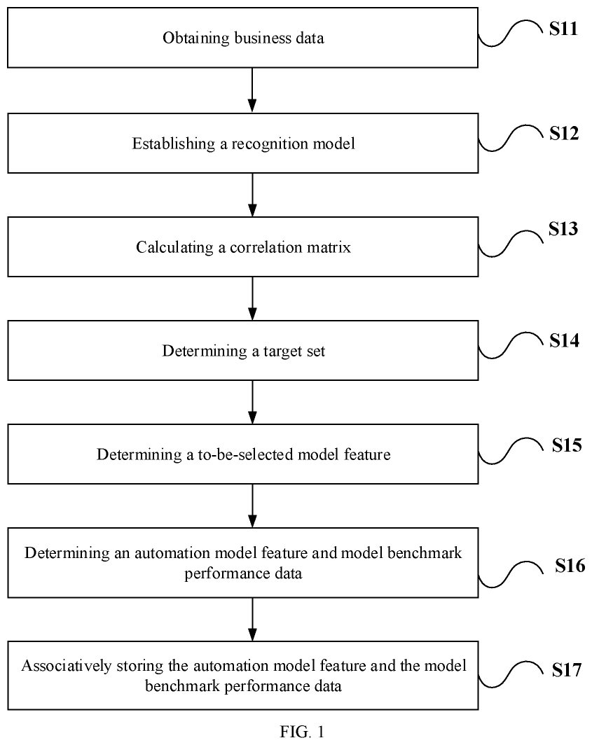

To resolve the above technical problems, the present invention provides a data feature processing method and a data feature processing apparatus. FIG. 1 is a schematic flowchart of a data feature processing method. The method is applied to a data processing server, and may specifically include the following steps.

Step S11: Obtain a plurality of groups of business data.

In this embodiment, each group of business data includes n data features, and n is a positive integer. For example, in the field of credit risk control, information entered by a user and attribute data including repayment willingness data and repayment ability data of a compliant Internet financial user are obtained by using application software of a terminal device or a web page. The repayment willingness data is mainly used to determine a fraud risk, such as an identity fraud, a dark industry chain, a deadbeat Gang, an intermediary fraud, or credit blacklist whitewashing. The repayment ability data, for example, includes consumption behavior data, transaction behavior data, travel behavior data, and multi-application data.

Step S12: Sort the plurality of groups of business data in a reverse chronological order of business data obtaining time to obtain a business data sorting sequence; determine highly-ranked business data of a first predetermined proportion as a cross-time validation set, and lowly-ranked business data of a second predetermined proportion as modeling sample data; and take a data feature corresponding to the modeling sample data as a model feature, and establish a recognition model by using a preset classifier.

In this embodiment, a sum of the first predetermined proportion and the second predetermined proportion is 1. Specifically, the first predetermined proportion may be 20%, and the second predetermined proportion may be 80%. The cross-time validation set is a latest sample selected based on a time dimension. A training set and a test set are obtained through random division, so that the two data sets do not have a same time distribution as an original data set. However, the cross-time validation set ensures consistency between a distribution and a real environment, and is generally used to validate model performance after modeling.

Further, the modeling sample data may provide a basis for obtaining a 5-fold cross-validation training set and test set through division. 5-fold cross-validation algorithmic logic randomly divides a modeling sample into a training set and a test set for five times, with the training set accounting for 80% of the modeling sample and the test set accounting for 20% of the modeling sample in each division. After each division, a model is established and an AUC value of the model in the corresponding test set is calculated. Finally, an average value of five calculated AUC values is obtained as an AUC value in the 5-fold cross-validation test set.

In addition, the preset classifier may be determined based on an XGBoost algorithm and its default parameter.

Step S13: Calculate feature importance values of the n data features based on the recognition model and a gain indicator of the recognition model, and calculate a correlation matrix of each data feature in the n data features by taking the modeling sample data as a benchmark.

In this embodiment, the correlation matrix may be an n*n matrix. The data features include repayment willingness features of an Internet financial user, for example, whether an identity of the Internet financial user is fake and whether the Internet financial user is a customer with a high overdue risk, and further include repayment ability features of the Internet financial user, such as an income level, a consumption behavior, and a travel behavior. A dependent variable is a repayment behavior feature. In the present invention, whether a quantity of overdue days for a first repayment exceeds 10 is taken as the dependent variable.

In this embodiment, a gain indicator refers to a relative contribution of the model that is obtained by calculating a contribution of each feature in each tree in the model. Compared with other features, a higher gain indicator means that it is more important for generating a prediction. Specifically, the feature importance value is calculated by dividing a total information gain of a data feature as a split node in an entire tree group by an occurrence frequency of the data feature.

In this embodiment, the correlation matrix may be a spearman correlation matrix, and is specifically calculated by using corr(‘spearman’) in python.

Step S14: Determine a plurality of target sets in the correlation matrix.

In this embodiment, there is no duplicate element between different target sets.

Step S15: Delete a data feature with a maximum feature importance value in each target set, merge remaining data features in each target set to obtain a feature set, and delete a data feature in the n data features being identical to a data feature in the feature set to obtain to-be-selected model features.

In this embodiment, the feature set includes m data features, the number of the to-be-selected model features is n−m, and m is a positive integer less than n.

Step S16: Import the to-be-selected model features into the preset classifier in batches in a descending order of the feature importance values, and obtain a difference between two pieces of adjacent first performance indicator data that is calculated by the preset classifier; determine whether the difference meets a preset condition; when the difference meets the preset condition, determine an automation model feature in the to-be-selected model features, and calculate second performance indicator data of the recognition model in the cross-time validation set; and determine model benchmark performance data based on the difference and the second performance indicator data.

Step S17: Associatively store the automation model feature and the model benchmark performance data.

It can be understood that upon the above steps S11 to S17, a highly-correlated feature can be deleted based on an order of the feature importance values. This can reduce operation time and memory demands in a model establishment process, reduce model complexity to facilitate practical application and maintenance of the model, and realize more reasonable feature selection. This can also greatly reduce, based on feature importance and model performance, resources consumed for model operation, while ensuring the model performance.

In an alternative implementation, the step of determining the plurality of target sets in the correlation matrix in step S14 may specifically include the following substep: selecting, from the correlation matrix, a row name and a column name of a correlation coefficient in a predetermined value range, and establishing a plurality of first sets; and merging first sets including an identical element to obtain the plurality of target sets.

For example, a set, namely, (row name, column name), is established by using row and column names corresponding to correlation coefficients greater than 0.8 and less than 1 in the correlation matrix. Finally, y small sets are obtained, in other words, there are y pairs of variables whose correlation is greater than 0.8. If there is an identical element in the y small sets, sets including the identical element are merged, and duplicate items are removed from a merged set. Finally, z large sets are obtained (there is not any duplicate element in the z sets). For example, a set 1 (var1, var3), a set 2 (var3, var8), a set 3 (var4, var5), a set 4 (var4, var9), and a set 5 (var4, var6) need to be merged as two large sets (var1, var3, var8) and (var4, var5, var6, var9), and there is no duplicate element in the finally two merged large sets.

Further, the step of importing the to-be-selected model features into the preset classifier in batches in the descending order of the feature importance values, and obtaining the difference between two pieces of adjacent first performance indicator data that is calculated by the preset classifier in step S16 may specifically include the following substeps S1611 to S1613.

Step S1611: Sort the to-be-selected model features in the descending order of the feature importance values to obtain a sequence of the to-be-selected model features.

Step S1612: Import first x to-be-selected model features in the sequence into the preset classifier, and calculate first performance indicator data corresponding to x to-be-selected model features in a test set of the preset classifier in a predetermined validation mode; and import first 2x to-be-selected model features in the sequence into the preset classifier, and calculate first performance indicator data corresponding to 2x to-be-selected model features in the test set of the preset classifier in the predetermined validation mode, where x is a positive integer.

Step S1613: Calculate a difference between the first performance indicator data corresponding to the 2x to-be-selected model features and the first performance indicator data corresponding to the x to-be-selected model features.

In this embodiment, the predetermined validation mode may be 5-fold cross validation, and a value of x may be 5.

Based on the above descriptions, the step of determining whether the difference meets the preset condition in step S16 specifically includes: determining whether the difference is greater than a predetermined threshold; if the difference is greater than the predetermined threshold, determining that the difference does not meet the preset condition; and if the difference is less than or equal to the predetermined threshold, determining that the difference meets the preset condition.

Further, the step of determining the model benchmark performance data based on the difference and the second performance indicator data in step S16 may specifically include the following steps S1621 and S1622.

Step S1621: Calculate third performance indicator data corresponding to x to-be-selected model features in a training set of the preset classifier in the predetermined validation mode.

Step S1622: Determine the third performance indicator data corresponding to the x to-be-selected model features in the training set of the preset classifier in the predetermined validation mode, the first performance indicator data corresponding to the x to-be-selected model features in the test set of the preset classifier in the predetermined validation mode, and the second performance indicator data to be the model benchmark performance data.

Based on step S16, when the difference does not meet the preset condition, first 3x to-be-selected model features in the sequence are imported into the preset classifier, and first performance indicator data corresponding to 3x to-be-selected model features in the test set of the preset classifier in the predetermined validation mode is calculated. A difference between the first performance indicator data corresponding to the 3x to-be-selected model features and the first performance indicator data corresponding to the 2x to-be-selected model features is calculated, and the step of determining whether the difference meets the preset condition is performed.

The following describes an implementation process of step S16 by using a specific example.

The to-be-selected model features are sorted in the descending order of the feature importance values by taking the modeling sample data as a benchmark and by using the XGBoost algorithm and its default parameter as a classifier. 1^{st} to 5^{th} to-be-selected model features are added to the classifier, and an average AUC value a1 of the classifier in the test set in 5-fold cross validation is calculated to obtain a 1^{st} average AUC value. Then, 1^{st} to 10^{th} features are added to the classifier, an average AUC value a2 of the classifier in the test set in 5-fold cross validation is calculated, and whether a2-a1 is greater than the threshold value 0.005 of the average AUC difference. If a2−a1 is greater than 0.005, 1^{st} to 15^{th} features are continuously added to the classifier, and so on. Finally, when a difference obtained by subtracting a (k−1)^{th} average AUC value from a k^{th} average AUC value is less than 0.005 input in the first step, the operation is terminated, and features of a (k−1)^{th} model are used as automation model features and stored as a list file. In addition, an AUC value of the model in a cross-time sample is calculated as a basis for subsequent modeling parameter adjustment, and an average AUC value in a (k−1)^{th} training set, an average AUC value in a (k−1)^{th} test set, and an average AUC value in a (k−1)^{th} cross-time sample are separately stored as the benchmark performance of the model.

It can be understood that the first performance indicator data corresponding to the x to-be-selected model features corresponds to a1, the first performance indicator data corresponding to the 2x to-be-selected model features corresponds to a2, the first performance indicator data corresponding to the 3x to-be-selected model features corresponds to a3, and so on.

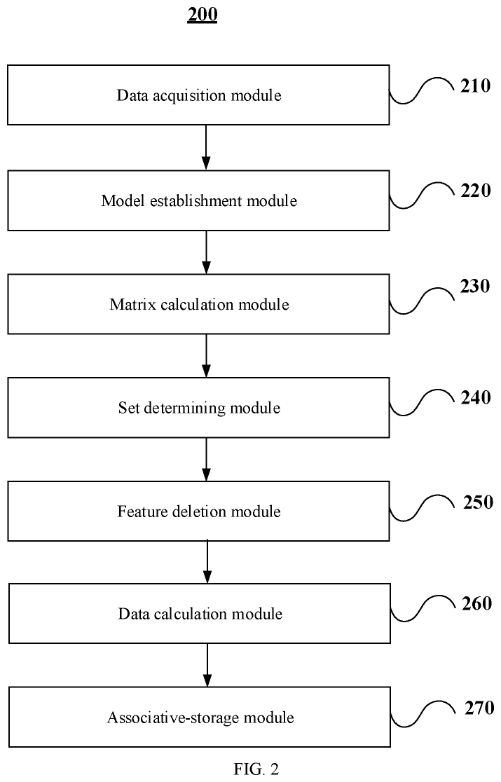

Based on the above inventive concept, a data feature processing apparatus 200 is provided, as shown in FIG. 2. The apparatus is applied to a data processing server, and includes:

a data acquisition module 210, configured to obtain a plurality of groups of business data, where each group of business data includes n data features, and n is a positive integer;

a model establishment module 220, configured to: sort the plurality of groups of business data in a reverse chronological order of business data obtaining time to obtain a business data sorting sequence; determine highly-ranked business data of a first predetermined proportion as a cross-time validation set, and lowly-ranked business data of a second predetermined proportion as modeling sample data; and take a data feature corresponding to the modeling sample data as a model feature, and establish a recognition model by using a preset classifier, where a sum of the first predetermined proportion and the second predetermined proportion is 1;

a matrix calculation module 230, configured to: calculate feature importance values of the n data features based on the recognition model and a gain indicator of the recognition model, and calculate a correlation matrix of each data feature in the n data features by taking the modeling sample data as a benchmark, where the correlation matrix is an n*n matrix;

a set determining module 240, configured to determine a plurality of target sets in the correlation matrix, where there is no duplicate element between different target sets;

a feature deletion module 250, configured to: delete a data feature with a maximum feature importance value in each target set, merge remaining data features in each target set to obtain a feature set, and delete a data feature in the n data features being identical to a data feature in the feature set to obtain to-be-selected model features, where the feature set includes m data features, the number of the to-be-selected model features is n−m, and m is a positive integer less than n;

a data calculation module 260, configured to: import the to-be-selected model features into the preset classifier in batches in a descending order of the feature importance values, and obtain a difference between two pieces of adjacent first performance indicator data that is calculated by the preset classifier; determine whether the difference meets a preset condition; when the difference meets the preset condition, determine an automation model feature in the to-be-selected model features, and calculate second performance indicator data of the recognition model in the cross-time validation set; and determine model benchmark performance data based on the difference and the second performance indicator data; and

an associative-storage module 270, configured to associatively store the automation model feature and the model benchmark performance data.

Optionally, the set determining module 240 is specifically configured to: select, from the correlation matrix, a row name and a column name of a correlation coefficient in a predetermined value range, and establish a plurality of first sets; and merge first sets including an identical element to obtain the plurality of target sets; and

the data calculation module 260 is specifically configured to: sort the to-be-selected model features in the descending order of the feature importance values to obtain a sequence of the to-be-selected model features; import first x to-be-selected model features in the sequence into the preset classifier, and calculate first performance indicator data corresponding to x to-be-selected model features in a test set of the preset classifier in a predetermined validation mode; import first 2x to-be-selected model features in the sequence into the preset classifier, and calculate first performance indicator data corresponding to 2x to-be-selected model features in the test set of the preset classifier in the predetermined validation mode, where x is a positive integer; and calculate a difference between the first performance indicator data corresponding to the 2x to-be-selected model features and the first performance indicator data corresponding to the x to-be-selected model features.

Optionally, the data calculation module 260 is further configured to:

determine whether the difference is greater than a predetermined threshold;

if the difference is greater than the predetermined threshold, determine that the difference does not meet the preset condition; and

if the difference is less than or equal to the predetermined threshold, determine that the difference meets the preset condition; and

the data calculation module is further configured to:

calculate third performance indicator data corresponding to x to-be-selected model features in a training set of the preset classifier in the predetermined validation mode; and

determine the third performance indicator data corresponding to the x to-be-selected model features in the training set of the preset classifier in the predetermined validation mode, the first performance indicator data corresponding to the x to-be-selected model features in the test set of the preset classifier in the predetermined validation mode, and the second performance indicator data to be the model benchmark performance data.

Optionally, the data calculation module 260 is further configured to:

when the difference does not meet the preset condition, import first 3x to-be-selected model features in the sequence into the preset classifier, and calculate first performance indicator data corresponding to 3x to-be-selected model features in the test set of the preset classifier in the predetermined validation mode; and

calculate a difference between the first performance indicator data corresponding to the 3x to-be-selected model features and the first performance indicator data corresponding to the 2x to-be-selected model features, and perform the step of determining whether the difference meets the preset condition.

For descriptions about the above functional modules, refer to descriptions of the method shown in FIG. 1. Details are not described herein again.

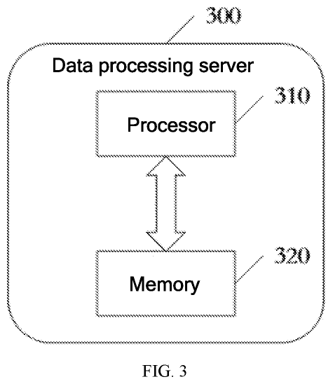

Based on the above descriptions, a data processing server 300 is provided. FIG. 3 shows a hardware structure of the data processing server 300. The data processing server 300 includes a processor 310 and a memory 320 that communicate with each other. The processor 310 retrieves a computer program from the memory 320 and runs the computer program to implement the method shown in FIG. 1.

To sum up, the data feature processing method and the data feature processing apparatus provided in the embodiments of the present invention perform the following operations: sorting a plurality of groups of obtained business data in a sequential order of business data obtaining time, to obtain a business data sorting sequence, determining a cross-time validation set and modeling sample data, taking a data feature corresponding to the modeling sample data as a model feature, and establishing a recognition model by using a preset classifier; calculating feature importance values of data features in the business data based on the recognition model and a gain indicator of the recognition model, and calculating a correlation matrix by taking the modeling sample data as a benchmark; determining to-be-selected model features based on the correlation matrix; and importing the to-be-selected model features into the preset classifier in batches; obtaining a difference between two pieces of adjacent first performance indicator data that is calculated by the preset classifier; when the difference meets a preset condition, determining an automation model feature in the to-be-selected model features, and calculating second performance indicator data of the recognition model in the cross-time validation set; and determining model benchmark performance data based on the difference and the second performance indicator data.

In this way, a highly-correlated feature can be deleted based on an order of the feature importance values. This can reduce operation time and memory demands in a model establishment process, reduce model complexity to facilitate practical application and maintenance of the model, and realize more reasonable feature selection. This can also greatly reduce, based on feature importance and model performance, resources consumed for model operation, while ensuring the model performance.

Described above are merely embodiments of the present invention, and are not intended to limit the present invention. Various changes and modifications can be made to the present invention by those skilled in the art. Any modifications, equivalent replacements, improvements, etc. made within the spirit and scope of the present invention should be included within the protection scope of the claims of the present invention.

What is claimed is:

1. A data feature processing method, wherein the method is implemented by a computer program on a memory and processor of a data processing server, the method further comprising:
obtaining a plurality of groups of business data, wherein the business data comprises user data obtained using application software, further wherein each group of business data comprises n data features, and n is a positive integer;
sorting the plurality of groups of business data in a reverse chronological order of business data obtaining time to obtain a business data sorting sequence; determining highly-ranked business data of a first predetermined proportion as a cross-time validation set, and lowly-ranked business data of a second predetermined proportion as modeling sample data; and taking a data feature corresponding to the modeling sample data as a model feature, and establishing a recognition model by using a preset classifier, wherein a sum of the first predetermined proportion and the second predetermined proportion is 1;
calculating feature importance values of the n data features based on the recognition model and a gain indicator of the recognition model, and calculating a correlation matrix of each data feature in the n data features by taking the modeling sample data as a benchmark, wherein the correlation matrix is an n*n matrix;
determining a plurality of target sets in the correlation matrix, wherein there is no duplicate element between different target sets;
deleting a data feature with a maximum feature importance value in each target set, merging remaining data features in each target set to obtain a feature set, and deleting a data feature in the n data features being identical to a data feature in the feature set to obtain to-be-selected model features, wherein the feature set comprises m data features, a number of the to-be-selected model features is n−m, and m is a positive integer less than n;
importing the to-be-selected model features into the preset classifier in batches in a descending order of the feature importance values, and obtaining a difference between two pieces of adjacent first performance indicator data that is calculated by the preset classifier; determining whether the difference meets a preset condition; when the difference meets the preset condition, determining an automation model feature in the to-be-selected model features, and calculating second performance indicator data of the recognition model in the cross-time validation set; and
determining model benchmark performance data based on the difference and the second performance indicator data; and
associatively storing the automation model feature and the model benchmark performance data;
wherein deleting the data feature reduces operation time and memory demands in a model establishment process, reduce model complexity to facilitate practical application and maintenance of the model, and reduce resources consumed for model operations while ensuring the model performance.

2. The data feature processing method according to claim 1, wherein the step of determining the plurality of target sets in the correlation matrix comprises:
selecting, from the correlation matrix, a row name and a column name of a correlation coefficient in a predetermined value range, and establishing a plurality of first sets; and
merging first sets comprising an identical element to obtain the plurality of target sets.

3. The data feature processing method according to claim 1, wherein the step of importing the to-be-selected model features into the preset classifier in batches in the descending order of the feature importance values, and obtaining the difference between two pieces of adjacent first performance indicator data that is calculated by the preset classifier comprises:
sorting the to-be-selected model features in the descending order of the feature importance values to obtain a sequence of the to-be-selected model features;
importing first x to-be-selected model features in the sequence into the preset classifier, and calculating first performance indicator data corresponding to x to-be-selected model features in a test set of the preset classifier in a predetermined validation mode;
importing first 2x to-be-selected model features in the sequence into the preset classifier, and calculating first performance indicator data corresponding to 2x to-be-selected model features in the test set of the preset classifier in the predetermined validation mode, wherein x is a positive integer; and
calculating a difference between the first performance indicator data corresponding to the 2x to-be-selected model features and the first performance indicator data corresponding to the x to-be-selected model features.

4. The data feature processing method according to claim 3, wherein the step of determining whether the difference meets the preset condition comprises:
determining whether the difference is greater than a predetermined threshold;
when the difference is greater than the predetermined threshold, determining that the difference does not meet the preset condition; and
when the difference is less than or equal to the predetermined threshold, determining that the difference meets the preset condition.

5. The data feature processing method according to claim 4, wherein the step of determining the model benchmark performance data based on the difference and the second performance indicator data comprises:
calculating third performance indicator data corresponding to x to-be-selected model features in a training set of the preset classifier in the predetermined validation mode; and
determining the third performance indicator data corresponding to the x to-be-selected model features in the training set of the preset classifier in the predetermined validation mode, the first performance indicator data corresponding to the x to-be-selected model features in the test set of the preset classifier in the predetermined validation mode, and the second performance indicator data to be the model benchmark performance data.

6. The data feature processing method according to claim 4, further comprising:
when the difference does not meet the preset condition, importing first 3x to-be-selected model features in the sequence into the preset classifier, and calculating first performance indicator data corresponding to 3x to-be-selected model features in the test set of the preset classifier in the predetermined validation mode; and
calculating a difference between the first performance indicator data corresponding to the 3x to-be-selected model features and the first performance indicator data corresponding to the 2x to-be-selected model features, and performing the step of determining whether the difference meets the preset condition.

7. A data feature processing apparatus, applied to a hardware structure of a data processing server, including a processor and a memory, further comprising:
a data acquisition module, configured to obtain a plurality of groups of business data, wherein the groups of business data comprises user data obtained using application software, further wherein each group of business data comprises n data features, and n is a positive integer;
a model establishment module, configured to: sort the plurality of groups of business data in a reverse chronological order of business data obtaining time to obtain a business data sorting sequence; determine highly-ranked business data of a first predetermined proportion as a cross-time validation set, and lowly-ranked business data of a second predetermined proportion as modeling sample data; and take a data feature corresponding to the modeling sample data as a model feature, and establish a recognition model by using a preset classifier, wherein a sum of the first predetermined proportion and the second predetermined proportion is 1;
a matrix calculation module, configured to: calculate feature importance values of the n data features based on the recognition model and a gain indicator of the recognition model, and calculate a correlation matrix of each data feature in the n data features by taking the modeling sample data as a benchmark, wherein the correlation matrix is an n*n matrix;
a set determining module, configured to determine a plurality of target sets in the correlation matrix, wherein there is no duplicate element between different target sets;
a feature deletion module, configured to: delete a data feature with a maximum feature importance value in each target set, merge remaining data features in each target set to obtain a feature set, and delete a data feature in the n data features being identical to a data feature in the feature set to obtain to-be-selected model features, wherein the feature set comprises m data features, a number of the to-be-selected model features is n−m, and m is a positive integer less than n;
a data calculation module, configured to: import the to-be-selected model features into the preset classifier in batches in a descending order of the feature importance values, and obtain a difference between two pieces of adjacent first performance indicator data that is calculated by the preset classifier; determine whether the difference meets a preset condition; when the difference meets the preset condition, determine an automation model feature in the to-be-selected model features, and calculate second performance indicator data of the recognition model in the cross-time validation set; and determine model benchmark performance data based on the difference and the second performance indicator data; and
an associative-storage module, configured to associatively store the automation model feature and the model benchmark performance data;
wherein deleting the data feature reduces operation time and memory demands in a model establishment process, reduce model complexity to facilitate practical application and maintenance of the model, and reduce resources consumed for model operations while ensuring the model performance.

8. The data feature processing apparatus according to claim 7, wherein the set determining module is specifically configured to:
select, from the correlation matrix, a row name and a column name of a correlation coefficient in a predetermined value range, and establish a plurality of first sets; and
merge first sets comprising an identical element to obtain the plurality of target sets;
the data calculation module is specifically configured to:
sort the to-be-selected model features in the descending order of the feature importance values to obtain a sequence of the to-be-selected model features;
import first x to-be-selected model features in the sequence into the preset classifier, and calculate first performance indicator data corresponding to x to-be-selected model features in a test set of the preset classifier in a predetermined validation mode;
import first 2x to-be-selected model features in the sequence into the preset classifier, and calculate first performance indicator data corresponding to 2x to-be-selected model features in the test set of the preset classifier in the predetermined validation mode, wherein x is a positive integer; and
calculate a difference between the first performance indicator data corresponding to the 2x to-be-selected model features and the first performance indicator data corresponding to the x to-be-selected model features.

9. The data feature processing apparatus according to claim 8, wherein
the data calculation module is further configured to:
determine whether the difference is greater than a predetermined threshold;
when the difference is greater than the predetermined threshold, determine that the difference does not meet the preset condition;
when the difference is less than or equal to the predetermined threshold, determine that the difference meets the preset condition;
calculate third performance indicator data corresponding to x to-be-selected model features in a training set of the preset classifier in the predetermined validation mode; and
determine the third performance indicator data corresponding to the x to-be-selected model features in the training set of the preset classifier in the predetermined validation mode, the first performance indicator data corresponding to the x to-be-selected model features in the test set of the preset classifier in the predetermined validation mode, and the second performance indicator data to be the model benchmark performance data.

10. The data feature processing apparatus according to claim 9, wherein
the data calculation module is further configured to:
when the difference does not meet the preset condition, import first 3x to-be-selected model features in the sequence into the preset classifier, and calculate first performance indicator data corresponding to 3x to-be-selected model features in the test set of the preset classifier in the predetermined validation mode; and
calculate a difference between the first performance indicator data corresponding to the 3x to-be-selected model features and the first performance indicator data corresponding to the 2x to-be-selected model features, and perform the step of determining whether the difference meets the preset condition.
